(19) United States
(12) Patent Application Publication
(10) Pub. No.: US 2005/0042578 A1
(43) Pub. Date: Feb. 24, 2005

(54) Driving simulator

(76) Inventors: Dieter Ammon, Remseck (DE); Friedrich Boettiger, Esslingen (DE); Enno Duplitzer, Stuttgart (DE); Ruediger Faul, Stuttgart (DE); Jochen Goetz, Jettingen (DE); Markus Hermle, Stuttgart (DE); Friedrich Hoffmeyer, Berlin-Friedenau (DE); Marc Laessing, Holzmaden (DE); Uwe Petersen, Stuttgart (DE); Joerg Russow, Weil der Stadt (DE); Thomas Schulz, Berlin (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/492,185

(22) PCT Filed: Aug. 21, 2002
(86) PCT No.: PCT/EP02/09301

(30) Foreign Application Priority Data
Oct. 11, 2001 (DE) 101503822

(51) Int. Cl. G09B 9/04; G09B 19/16

(52) U.S. Cl. 434/62

(57) ABSTRACT

A cascaded overall actuating system for a vehicle motion simulator is divided into an actuating system for small, high-frequency movements and an actuating system for large, low-frequency movements. A manipulator for implementing the low-frequency excitations is itself composed as a cascaded system of a rotary plate, a six-axle movement unit and a horizontal displacement device. To simulate movements which are as low in frequency as possible, the horizontal displacement device spans, as the actuator stage which is arranged at the lowest point in the cascade, a large movement area of 40 m×40 m. The six-axle movement unit with rotary plate and high-frequency actuating system is mounted on a carrier carriage which is supported in a freely displaceable fashion on a planar base surface bounded by the displacement paths of the horizontal displacement device and is pulled and/or pushed with respect to this base surface by means of the horizontal displacement device.

### BACKGROUND AND SUMMARY OF THE INVENTION

This application claims the priority of German patent document DE 101 50 382.2, filed Oct. 11, 2001 (PCT International Application No. PCT/EP02/09301, filed Aug. 21, 2002), the disclosure of which is expressly incorporated by reference herein.

The invention relates to a movement system for producing motion sensations on test persons.

In the field of motor vehicle construction there is great interest in the continued reduction of development times and costs. As a result, there is also a need to specify design margins in early development stages and to determine physical limits in order to be able to shorten the subsequent development phases and eliminate iteration loops. For this reason, information on the expected driving comfort (ride properties) and the driving behavior (handling properties) of a vehicle design must be available at a very early development stage in order to avoid development loops in the following costly and time-consuming implementation stages.

In order to test vehicle designs in early development stages, both off-line simulations and, in particular driving simulators, make it possible to submit a mathematical-synthetic vehicle design (including electronic control and regulating systems and already incorporated hardware components) which has been established in a computer, to be excited as desired by drivers, making it possible for the driver to “experience” such excitations. A driving simulator thus permits in principle virtual driving with a digital vehicle corresponding to a previous test run in a conventional development process. A necessary precondition for effective use of a driving simulator as a tool in the development of a vehicle is the ability to realistically simulate the largest possible number of driving maneuvers that relate to both driving comfort and to driving behavior, and combinations of these properties. For this purpose, on the one hand suitable systems and methods for visualizing traffic situations, for simulating vehicles and noises etc. must be available. On the other hand, it is necessary to make available a movement system which can be used to permit the driver to perceive accelerations and changes in accelerations under conditions which are as close as possible to reality, both with respect to the ride properties and the handling properties of the vehicle.

German patent document DE 39 36 877 A1 discloses a system for simulating real driving situations in which vehicle operator control elements (such as steering wheel, activation pedals etc.) are arranged so as to be movable with respect to the cabin of the vehicle. These operator control elements can be moved in a variable fashion in a plurality of directions of movement with respect to one another and with respect to the seat by means of assigned actuating elements which are actuated using a control unit. The types of movement are determined here from the type of vehicle movement to be simulated. The moving elements of the driving simulation in this case have very short displacement paths. For this reason, this system is suitable exclusively for simulating driving maneuvers in which high-frequency excitations (>3 Hz) play a significant role. Such a driving simulation system is thus restricted to testing the ride-related properties of the vehicle, for example the impression when driving on bumpy roads, when driving over kerbs etc.

Handling properties of the vehicle cannot be represented realistically using the system known from DE 39 36 877, A1 since low-frequency acceleration effects play a decisive role in their implementation. In order to be able to implement low-frequency excitations of the vehicle, driving simulators are used whose driver cabins are mounted so as to be movable in their entirety and are moved laterally and rotationally in different movement axles through specific distances and angular ranges. As a result, handling-related states such as accelerating, cornering, braking, etc. are produced. Such systems are known, for example, from German patent documents DE 28 42 409 A1 and EP 335 585 A1. The lower end of the achievable frequency spectrum is limited in these devices directly by the maximum available displacement distances of the driving simulator. Although, as described in German patent document DE 28 42 409 A1, it is possible to use what are referred to as washout algorithms to simulate relatively long-lasting horizontal accelerations by means of a rotary movement of the vehicle cabin, handling-related maneuvers in the frequency range below approximately 0.7 Hz are only represented in a very unsatisfactory fashion by such methods.

The NADS (National Advanced Driving Simulator, http://www.nads-sc.uiowa.edu) from the University of Iowa represents a first attempt at simulating both low-frequency (handling-related) excitations as well as high-frequency (ride-related) excitations in a single system. The system comprises an assembly of vehicle dome which is secured to a hexapod; and the assembly in turn is mounted on a pair of crossed linear axles with belt traction drives that can be used to move it over a base surface of 20 m×20 m. The wheels of the vehicle to be examined are connected to the baseplate of the dome by means of rams, by which it is possible to generate vertical excitations of the vehicle.

While the NADS permits, to a certain degree and in selected excitation directions, both handling-related and ride-related excitations, it has a number of significant drawbacks:
The ride actuating system of the NADS (vertical excitation of the vehicle wheels) in conjunction with the overall kinematics provides movement sensations which are insufficient for some driving situations; for example it is not possible to simulate realistically driving on bad stretches of road with the associated relatively high frequency horizontal accelerations (>20 Hz).
The base surface of the NADS is too small to be able to simulate realistically specific development-related driving maneuvers with important low-frequency components (for example changing lane with the brakes fully applied, braking on bends).

One object of the invention, therefore, is to provide a movement system for a driving simulator with which it is possible to simulate realistically a significantly larger number of development-related driving maneuvers in comparison with known movement systems.

This and other objects and advantages are achieved by the motion system according to the invention, which takes into account the proposition that excitations in both the low and high frequency ranges are necessary to simulate a large number of driving maneuvers under conditions which are close to reality. Accordingly, for this purpose a cascaded system is used in which the overall actuating system is divided into
an actuating system for small, high-frequency movements (which play a particularly important role in the simulation of low speeds) and
an actuating system for large, low-frequency movements (which play a particularly important role in the simulation of high speeds).

A multi-axle ride system whose significant features are known, for example, from German patent document DE 39 36 877 A1, is used as an actuating system for implementing the high-frequency excitations. That system comprises a cabin with a seat and operator control elements which are movably arranged and being able to be moved with respect to one another in a plurality of directions, by means of assigned actuating elements. According to the invention this ride system is fitted onto a multi-axle manipulator which serves as an actuating system for implementing the low-frequency excitations. The manipulator itself represents in turn a cascaded system and comprises a rotary plate, a six-axle movement unit and a horizontal displacement device. The ride system is thus mounted on the rotary plate and can be rotated about its vertical axle using the rotary plate. The assembly composed of the ride system and rotary plate is then mounted on the six-axle movement unit and is moved in a controlled fashion in the low-frequency range using this movement unit. The assembly composed of the ride system, rotary plate and six-axle movement unit is in turn moved along the two horizontal axes using the horizontal displacement device, to implement the lowest-frequency movements.

In order to be able to simulate the lowest possible frequency movements, the horizontal displacement device (as the actuator stage which is arranged at the lowest point in the cascade) must span the largest possible distances. However, it must be ensured that enlarging the movement surface entails only a very moderate enlargement of the masses to be moved since otherwise a large movement surface cannot be implemented due to the forces and moments which occur.

In order to satisfy this requirement, the six-axle movement unit is mounted according to the invention on a carrier carriage which is mounted in a freely displaceable fashion on a planar base surface. The latter is bounded by the displacement path of the horizontal displacement device and is pulled and/or pushed with respect to the base surface by means of the horizontal displacement device. The functions of providing support on the one hand, and guiding in the horizontal direction or absorbing the momentum in all three spatial directions, on the other hand, are separated by this design of the movement system. As a result, in comparison to the movement systems known from the prior art, a larger base surface can be covered with less mass to be moved. In particular, the movement system according to the invention makes it possible to cover a base surface of for example 40 m×40 m, which is accompanied by a considerable widening of the frequency spectrum of the driving simulator in the lowest frequency range.

In order to make displacements and accelerations of the base unit (composed of a carrier carriage, six-axle movement unit, rotary plate and cabin) free of jolting, the friction between the base unit and base surface must be as small as possible. The carrier carriage is therefore advantageously mounted with respect to the base surface by means of air bearings and/or air cushions. Such air bearing make the base unit freely displaceable on the base surface, and are associated with minimal friction forces between the base unit and base surface. Furthermore, the air bearings are characterized by a high degree of rigidity, which is an important precondition for disruption-free sliding of the base unit on the base surface. Alternatively, the base unit can also be mounted with respect to the base surface by means of sliding bearings or by means of roller bearings.

In particularly advantageous embodiments of the invention, the horizontal displacement device is composed of two linear displacement devices, specifically
a first linear displacement device for the controlled displacement and acceleration of the base unit along a first horizontal axis (Y direction); and
a second linear displacement device for the controlled displacement and acceleration of the assembly composed of the first linear displacement device and base unit, along a second horizontal axis (X direction) which is oriented approximately perpendicularly with respect to the first horizontal axis.

This refinement of the horizontal displacement device permits further cascading of the movement system since the horizontal movement (over a large surface) of the base unit is carried out by means of two linear displacement devices which are connected to one another hierarchically.

Between successive cascade stages there should be only minimal interactions or couplings in order to make a modular overall regulation of the movement system possible. As a result, the complexity of the system is reduced and controllability is improved.

The second linear displacement device is expediently embodied as a gantry bridge. The term gantry bridge is intended in this context to be understood as a displacement device which spans the entire width of the base surface transversely with respect to its direction of movement, is supported on its two transverse ends on rails (or alternative guide means) and is displaced and accelerated with respect to the base surface by means of linear drives that are arranged or act on the two transverse ends of the gantry bridge. The gantry bridge on the one hand passes on the drive forces—applied via the linear drives—in the X direction on the base unit, and on the other hand conducts away the reaction forces of the base unit in the X direction to the linear drives

The gantry bridge should have the highest possible degree of local rigidity in order to ensure good decoupling of the X and Y movements of the linear displacement devices and in order to keep as low as possible the forces and loads which are exerted on the gantry bridge by the first linear displacement devices when the base unit is accelerated. On the other hand, the mass of the gantry bridge should be as small as possible in order to minimize the forces necessary to accelerate and brake the moved masses of the driving simulator. In order to satisfy these two requirements, the supporting structure of the gantry bridge is expediently constructed as a lattice structure which can be used to distribute over the entire gantry bridge the forces which are applied to the connection point of the first linear displacement device. In the connection area of the first linear displacement device, the gantry bridge also expediently has a reinforced vertical carrier by means of which a particularly high degree of local rigidity can be brought about.

The gantry bridge is supported at its two transverse ends on the base surface or on suitably designed rails. Depending on the size of the base surface to be spanned and the weight of the gantry bridge it may be advantageous to provide, in addition to this support at the ends of the gantry bridge, further supports in the central region of the gantry bridge. The supports expediently have air-bearings with respect to the base surface in order to permit the gantry bridge to slide with respect to the base surface with as little friction as possible.

Movement excitation of the gantry bridge can be provided by means of belt traction drives, using prestressed belts (particularly steel belts), which run in the Y direction, are attached to the transverse ends of the gantry bridge and run around a drum at each of the ends of the movement field. The drums, which can exert a traction force on the respective belt (and thus on the end of the gantry bridge which is permanently connected to the belt), are driven by means of electric motors. In order to orient the gantry bridge precisely, the two belt traction drives must be controlled synchronously.

Alternatively, movement excitation of the gantry bridge can be performed by two electric linear drives which are arranged at the two transverse ends of the gantry bridge. In comparison with belt traction drives, this solution has the advantage of a more compact design since the runners are arranged directly at the ends of the gantry bridge and the stationary elements can be integrated in the rails. Furthermore, when electric linear drives are used, in contrast to belt traction drives, the risk of uncoordinated mechanical excitations of oscillations of the system is largely prevented. Since electric linear drives do not require any intermediate transmission, they are also particularly low in friction. In order to orient the gantry bridge precisely, the two electric linear drives must be actuated synchronously.

By virtue of synchronous control of the two drive motors which act on the ends of the gantry bridge, as described above, it is possible largely to prevent twisting of the gantry bridge about the vertical axis during normal operation. However, in the event of a fault, considerable twisting may occur. For this reason it is expedient to provide a mechanism which can be used to compensate for twisting of the gantry bridge and to avoid damage to the gantry bridge due to irreversible warping. For this purpose, one end of the gantry bridge is mounted in a rotatable fashion with respect to the drive element which acts on that end, while the connection of the other end of the gantry bridge to the drive element which acts at this point is made by means of a rotary connection which is linearly displaceable to a limited degree in the Y direction.

In order to displace and accelerate the base unit in the Y direction in a controlled fashion, a second linear displacement device, preferably formed by an electric linear direct drive, is provided on the gantry bridge. In order to avoid twisting and tilting of the base unit with respect to the second displacement device, the carrier carriage of the base unit is expediently supported with respect to the second linear displacement device by means of coupling elements. Such coupling elements permit twisting in any spatial directions between the base unit and second linear displacement unit to be compensated. In one particularly advantageous embodiment of the coupling elements, the rotor of the electric linear drive is connected to two passive elements which are offset with respect to the rotor in the Y direction and are coupled to it by means of spring damper elements. The base unit is connected to the rotor of the electric linear drive by means of a multi-jointed strut and to the two passive elements by means of pivotable struts.

In order to bring about the lowest possible degree of wear of the movement system due to warping of the gantry bridge, and to avoid associated disruptive accelerations, the reaction forces exerted on the gantry bridge by the base unit must be applied to it with as little momentum as possible. For this purpose, the connection points of the base unit to the gantry bridge are advantageously at the level of the center of gravity of the gantry bridge, so that the application of all the horizontal forces to the gantry bridge takes place at the level of the center of gravity of the gantry bridge. Furthermore, it is expedient also to arrange the rails of the gantry bridge—via which the reaction forces of the base unit in the X direction are conducted away to the linear drives—at this level. If the level of the gantry bridge is relative to the base unit is such that the horizontal force flux from and to the base unit takes place at the level of the center of gravity of the base unit, the vertical bearings of the base unit can be relieved of the need (which otherwise occurs) to absorb additional forces due to supporting moments.

In order to avoid serious damage to the movement system when operating faults (in particular, power failures) occur, the drives of the two linear displacement devices are expediently provided with passive brake systems (for example eddicurrent brakes) by means of which rapid automotive braking of the horizontal axes of the movement system can be brought about in an emergency. Furthermore, end stops are provided on both axles. In order also to ensure that, in the event of a power failure, the air bearing of the base unit is maintained at least until the base unit comes to a complete stop, it is also recommended to provide a pressure reservoir.

As an alternative to two linear displacement devices which are arranged in a cascaded fashion, the horizontal displacement device can also be implemented by means of belt traction drives which cross over. Here, the cascading of the X and Y movements is eliminated, and the masses which are to be moved with high quality are minimized. In order to ensure highly precise control of the movement of the base unit, it is recommended to provide two belt traction drives which run in parallel, in the respective X and Y directions, and which are each controlled synchronously.

In a further embodiment, the horizontal displacement device is formed by an electromagnetic planar drive. For this purpose, a regular grid of magnets is provided in the base surface. Furthermore, displacement shoes are provided which can be displaced with low friction (for example by means of air bearings) with respect to the base surface. Each of the displacement shoes is fitted with an arrangement of electromagnetic coils which can be used to displace the displacement shoe in a deliberate fashion with respect to the magnets of the base surface. The base unit which is mounted on the carrier carriage is mechanically coupled to the displacement shoe or shoes, and is moved with respect to base surface using the displacement shoes. In order to minimize the moments which are exerted on the displacement shoes during the movement, or to distribute them as symmetrically as possible, it is advantageous to provide at least two displacement shoes and to arrange them symmetrically around the carrier carriage. The plurality of displacement shoes are moved in parallel and synchronously with one another so that the carrier carriage assumes a fixed spatial position with respect to the displacement shoes.

The six-axle movement unit which is arranged on the carrier carriage is expediently moved using electric drives. In contrast to a hydraulic drive, which is very complex in terms of apparatus and is associated with large and heavy assemblies, pumps, high-pressure lines etc., driving the movement unit electrically has the advantage of being comparatively simple in terms of apparatus, easier to handle and significantly lighter.

A hexapod is advantageously used as a six-axle movement unit. Such a hexapod comprises six struts which are secured to the carrier carriage, are adjustable in terms of their length and have a movement platform attached to their ends. This permits the movement platform to move in all six degrees of freedom, i.e. in three translatory degrees of freedom and three rotary degrees of freedom, in which case it can be ensured that a large amount of force is taken up. Hexapods are known, for example, from German patent document DE 196 36 100 A1 and International patent document WO99/55488.

In order to achieve visual and auditory separation between the cabin and the surroundings (simulator hall and movement system), it is expedient to provide above the movement platform of the hexapod a dome or enclosure which surrounds the vehicle cabin on all sides. The enclosure provides a projection surface for a driving simulator visualization system by means of which the traffic scenarios are displayed during the trial run. The enclosure acoustically dampens the operating noises of the movement system with respect to the interior of the dome. This ensures that the noises generated in the sound system of the vehicle cabin during the test run are not falsified by extraneous operating noises.

Other objects, advantages and novel features of the present invention will become apparent from the following detailed description of the invention when considered in conjunction with the accompanying drawings.

### BRIEF DESCRIPTION OF THE DRAWINGS

FIG. 1a is a schematic plan view of a motion simulator system according to the invention for a driving simulator;

FIG. 1b is a side view of the motion system in FIG. 1a;

FIG. 2a is a schematic view of the base unit of the motion system in the side view in FIG. 1b;

FIG. 2b shows the air bearing of the base unit in a schematic sectional view;

FIG. 3 shows a side view of the motion system in FIG. 1a with a band drive of the gantry bridge;

FIG. 4 shows a view of a detail of an electromagnetic linear drive of the gantry bridge indicated by the circled section IV in FIG. 2a;

FIG. 5 is a schematic view of tilting of the gantry bridge;

FIG. 6a is a schematic view of the connection of the base unit to the gantry bridge by means of coupling elements in a plan view in the Z direction;

FIG. 6b shows the connection of the base unit to the gantry bridge according to FIG. 6a in a plan view in the X direction;

FIG. 7a is a schematic plan view of a horizontal displacement device which is driven by means of belt drives;

FIG. 7b is a lateral sectional view of the horizontal displacement device in FIG. 7a;

FIG. 8a is a schematic plan view of a horizontal displacement device which is driven by means of planar drives;

FIG. 8b is a detailed view of the base surface in FIG. 8a;

FIG. 8c is a lateral sectional view of the horizontal displacement device with planar drives according to FIG. 8a;

FIG. 9 shows a perspective view of an electromagnetically driven hexapod;

FIG. 10a is a schematic X-Z sectional view of an actuating system for a driver's seat; and

FIG. 10b is a schematic X-Y sectional view of the actuating system of a driver's seat in FIG. 10a.

### DETAILED DESCRIPTION OF THE DRAWINGS

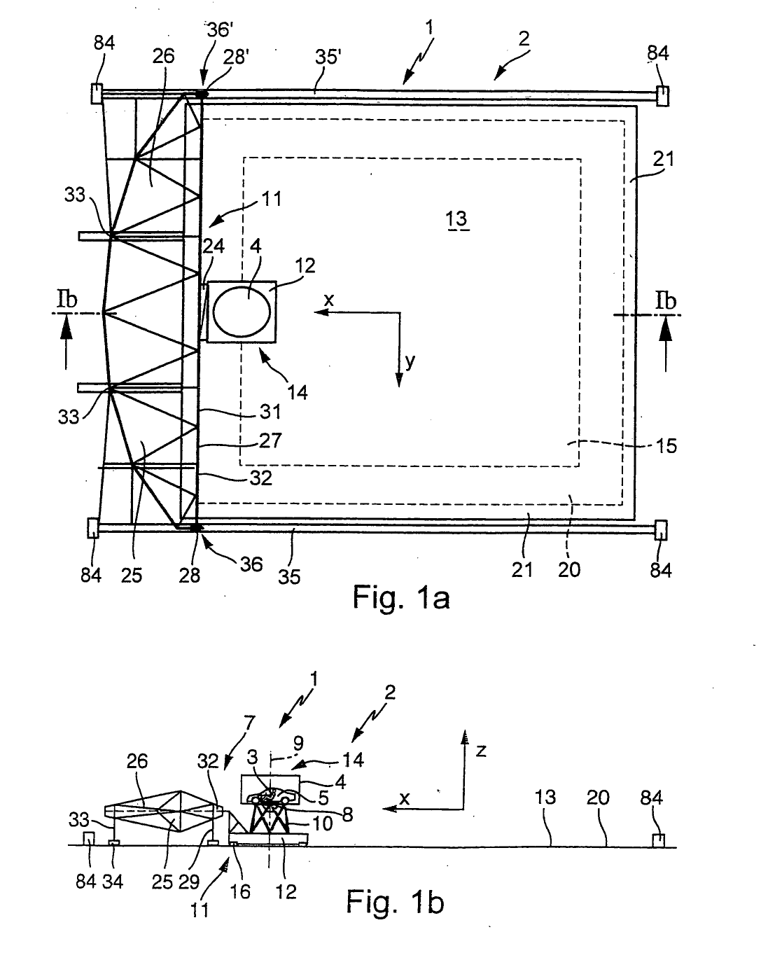

FIGS. 1a and 1b show a schematic plan view (FIG. 1a), and a side view (FIG. 1b) of a movement system 1 for a driving simulator 2 for producing sensations of movement on a test person 3. The movement system 1 comprises a cabin 5 which is surrounded by an enclosure 4 and has a ride actuating system 6 (described in more detail below). The cabin 5 is fixedly arranged on a manipulator 7, which itself comprises the following components:
a rotary plate 8 for the controlled rotational movement of the cabin 5 about its vertical axis 9,
a six-axle movement unit 10 for moving the assembly composed of the rotary plate 8 and cabin 5 in all six degrees of freedom (three translatory degrees of freedom and three rotational degrees of freedom),
a horizontal displacement device 11 for the controlled displacement and acceleration of the assembly composed of the six-axle movement unit 10, rotary plate 8 and cabin 5 along the two horizontal axes X and Y.

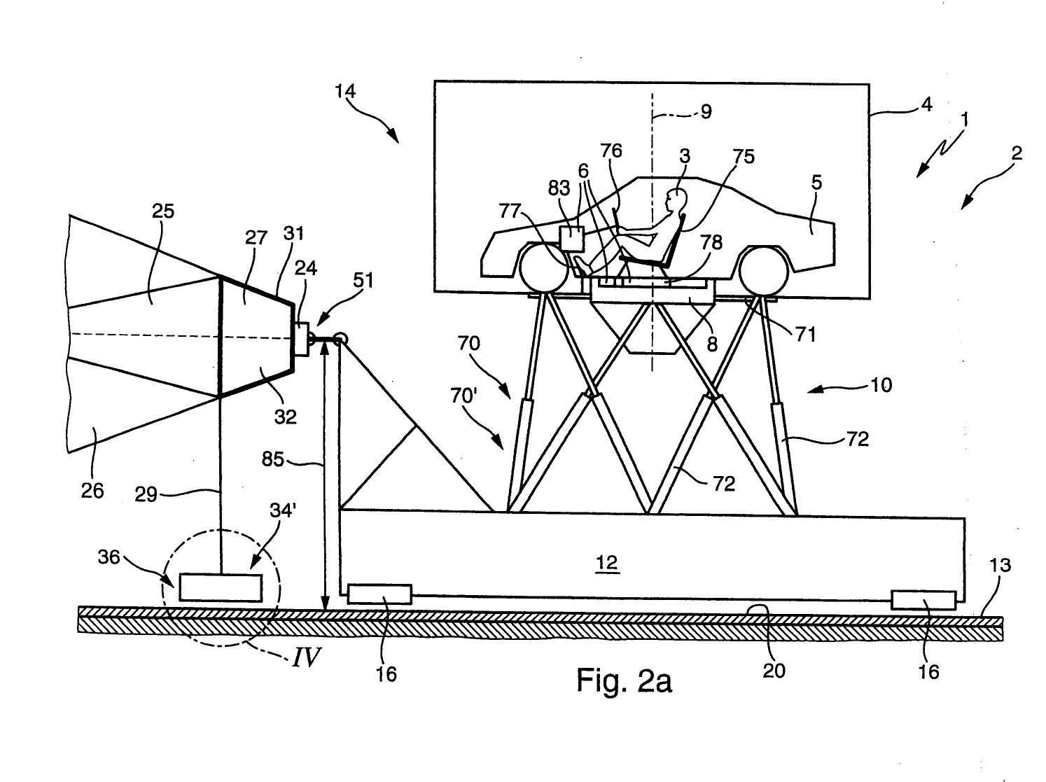

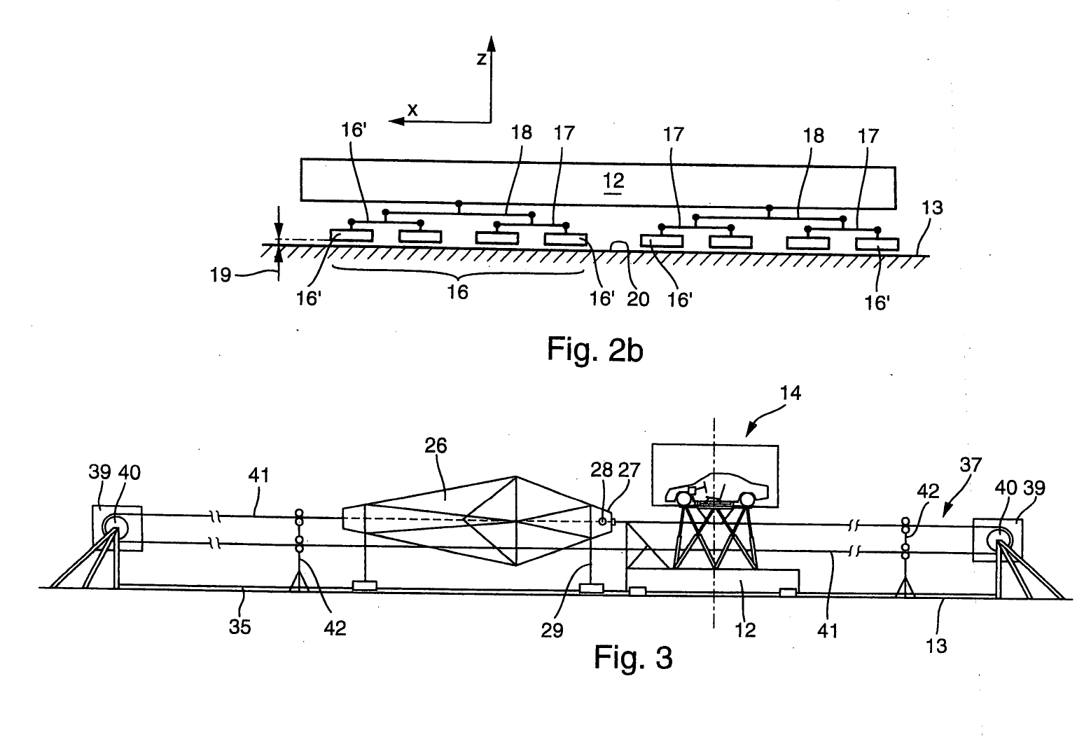

The six-axle movement unit 10 is mounted on a carrier carriage 12 which is arranged to be freely displaceable on a planar base surface 13 and is pulled and/or pushed with respect to the base surface 13 by means of the horizontal displacement device 11. The assembly composed of the carrier carriage 12, six-axle movement unit 10, rotary plate 8 and cabin 5 is referred to below as base unit 14. FIG. 2a shows a detailed view of this base unit 14 in a schematic sectional view.

The objective of the invention is to simulate a multiplicity of possible driving maneuvers under conditions which are close to reality using the driving simulator 2. The speeds and accelerations which are necessary for this therefore must be applied by means of the movement system 1. As a result, large movement areas are required in particular for representing low-frequency excitations. In the present example, an X-Y movement area 15 of 40 m×40 m was selected in the horizontal X and Y direction (the internal boundary of this area is represented by dashed lines in FIG. 1a). Simulations show that a movement area of this size can be used to simulate convincingly a majority of the relevant maneuvers in the development vehicle. In this context, the frequency range <1 Hz is covered in X and Y direction by the horizontal displacement device 11 and the rotary plate 8. Movements in the frequency range between approximately 1 Hz and approximately 3 Hz are implemented by means of the six-axle movement unit 10, while all the higher-frequency excitations are covered by means of the ride actuating system 6 and the rotary plate 8. However, the large dimensions of the X-Y movement area 15 imposes very high requirements on all the components of the movement unit 1 so that, as described below, both the configuration of the individual components and their interaction have to be matched in a selective way to the size of the X-Y movement area 15.

So that the speeds and accelerations necessary for the different maneuvers can be applied with high resolution and quality, the base unit 14 (several tons in weight) must be mounted with respect to the base surface 13 with as little friction as possible. This is implemented in the exemplary embodiment in FIGS. 1 and 2 by means of an air bearing 16 of the carrier carriage 12 with respect to the base surface 13 (represented schematically in a detailed view in FIG. 2b). In order to support the carrier carriage 12 with respect to plate surface 13 twenty seven identical air bearings 16′ are used, each of which contains (as illustrated schematically in FIG. 2.b)—in three main groups 18—three subgroups 17 with three individual bearings. Here, three individual bearings 16′ are connected via ball and socket joints to a carrier and thus form a subgroup 17. Three subgroups 17 are in turn connected to a further carrier, in each case by means of ball and socket joints, and thus form a main group 18. Each main group 18 is in turn connected to the carrier carriage 12, in each case by means of a ball and socket joint. This results in statically determined mounting of the carrier carriage 12 on the base surface 13. Furthermore, the base surface 13 must be embodied as a very level sliding surface 20.

The horizontal displacement device 11 is composed of two linear displacement devices 24, 25 in the exemplary embodiment in FIGS. 1 and 2. The base unit 14 is displaced and accelerated in the Y direction using the first linear displacement device 24. The assembly composed of the base unit 14 and first displacement device 24 is displaced and accelerated in the X direction using the second linear displacement device 25.

The second linear displacement device 25 is embodied as a gantry bridge 26 in the exemplary embodiment in FIGS. 1 and 2. The gantry bridge 26 comprises a crossmember 27 whose two ends 28, 28′ rest on feet 29 which are mounted so as to be displaceable with respect to the base surface 13. The crossmember 27 spans the entire sliding base 20 in the Y direction and thus spans a distance of 54 m in length, which is composed of the movement distance 30 in the Y direction (40 m), emergency run-off zones 21 (2×3 m), as well as the width of the carrier carriage 12 (8 m).

The crossmember 27 is a lightweight construction of steel and/or CFRP and is configured in such a way that it has the highest possible natural frequencies accompanied by a low weight, which is important in order to avoid, during the operation of the driving simulator 2, the excitation of natural frequencies of the crossmember 27 which unfavorably influence the representation of movement of the simulation system. The lowest frequency and thus relevant natural mode of the gantry bridge 26 is the first flexural vibration of the crossmember 27 about the vertical (Z) axis. In order to ensure that this natural frequency is not excited while the driving simulator 2 is operating, the natural frequency must be so high that all the forms of movement of the horizontal displacement device 11 ocurring during movement (with <1 Hz) and of the six-axle movement unit 10 (with up to 3 Hz) lie sufficiently far below the natural frequency. As a result, the crossmember 27 should produce, in this form of oscillation, a first natural frequency of sufficiently far above 3 Hz, while at the same time the mass of the structure 26 must not be above 40 t.

The latter requirements can be fulfilled, for example, with a lattice structure made of steel. The crossmember 27 must, in this case, have a high degree of local rigidity in the area 31 which faces and introduces the forces into the base unit 14 and in which the first linear displacement device 24 is connected. Therefore, in the exemplary embodiment in FIGS. 1 and 2, this area 31 is formed by a shell structure 32 made of welded steel plate. The rest of the structure of the crossmember 27 is constructed as an overspecified lattice. The rods or bars have circular tube-shaped or rectangular tube-shaped cross sections and are connected to one another in a frictionally locking and/or positively locking fashion.

In order to bring about the required flexural rigidity it is expedient to provide a multi-stage lattice structure. The shell structure 32 is made more rigid by means of an approximately 2 to 3 m-deep fine lattice structure which is arranged behind it; and the global rigidity of the structure is brought about by means of a further lattice which is mounted behind and has chords which are displaced 13 m to the rear.

In order to reduce sagging under its own weight minimize the installation space required in the vertical (Z) direction, the gantry bridge 26 is supported with respect to the base surface 13 by means of a plurality of supports 33 previously distributed in the Y direction. The supports 33 are mounted with respect to the base surface 13 by means of air bearings 34 or air sliding cushion elements in order to ensure that the gantry bridge 26 can be displaced in the X direction with low friction. The position and rigidity of the supports 33 are determined according to technical oscillation criteria.

In order to ensure statically determined bearing of the gantry bridge 26 in the Y direction, guides 35, 35′ are provided on both sides, with the gantry bridge 26 being mounted with respect to the guides 35, 35′ by means of a fixed bearing on the one side and a loose bearing on the other. In the bearings, moments about the vertical (Z) axis are not taken up so that jamming does not occur when the gantry bridge 26 bends and/or when there is slight inclination.

In order to move the gantry bridge 26 in the X direction in a controlled fashion, two drives 36, 36′ act on the two ends 28, 28′ of the gantry bridge 26. When suitable drives 36, 36′ are selected, in principle the following peripheral conditions are to be taken into account:
the movement area of the gantry bridge 26 (and thus the necessary working area of the drives 36, 36′) results from the dimensions of the base surface 13 and is therefore very large (in the exemplary embodiment under consideration here it comprises 54 m, as described above).
The maximum required driving force for the gantry bridge 26 in the X direction is approximately 300,000 N. This results from the acceleration of 0.6 g which is applied for extreme driving maneuvers and the permitted moved overall mass of the assembly composed of the gantry bridge 26 and base unit 14 of up to 50 t. In the dimensioning of the two individual drives 36, 36′, an extreme edge position of the base unit 14 is to be taken into consideration. This leads to fluctuations in the force requirements of the individual drives 36, 36′ of up to +/−20%. Each individual drive 36, 36′ must therefore apply a maximum force of 180,000 N.
A required drive power of 20 W/kg in the X direction results from simulation calculations with corresponding load profiles.
The acceleration resolution or acceleration quantization which is required for simulating selected driving maneuvers under conditions which are close to reality is 0.02 m/s². Thus, the driving force of the gantry bridge 26 must be capable of being metered more finely than 1000 N. In addition, design-related interfering forces (for example friction) must be smaller than 5000 N in order to ensure that errors in the representation of acceleration are less than 0.1 m/s².

In order to fulfill these requirements, according to one embodiment of the invention, a belt drive 37 is used to drive the gantry bridge 26 (see schematic representation in FIG. 3); electric motors 39 which drive a circulating prestressed endless steel belt 41 in a frictionally locking fashion by means of rollers 40 are installed at the extremities 38 of the guides 35, 35′ of the gantry bridge 26. This steel belt 41 is attached to the ends 28, 28′ of the crossmember 27 of the gantry bridge 26. Due to the large free length of the steel belt 41, natural oscillations of the belt 41 may occur, which lie in the region of the control bandwidth of the drive 37 and adversely affect the simulation of movement on the simulation system 2. In order to avoid such effects, it is advantageous to prestress the steel belt 41 and to provide additional support mechanisms 42 along the gantry bridge guiding means 35, so as to prevent low-frequency natural oscillations of the steel belts 41. Speed-transforming transmission may also be provided between the motor 39 and roller 40.

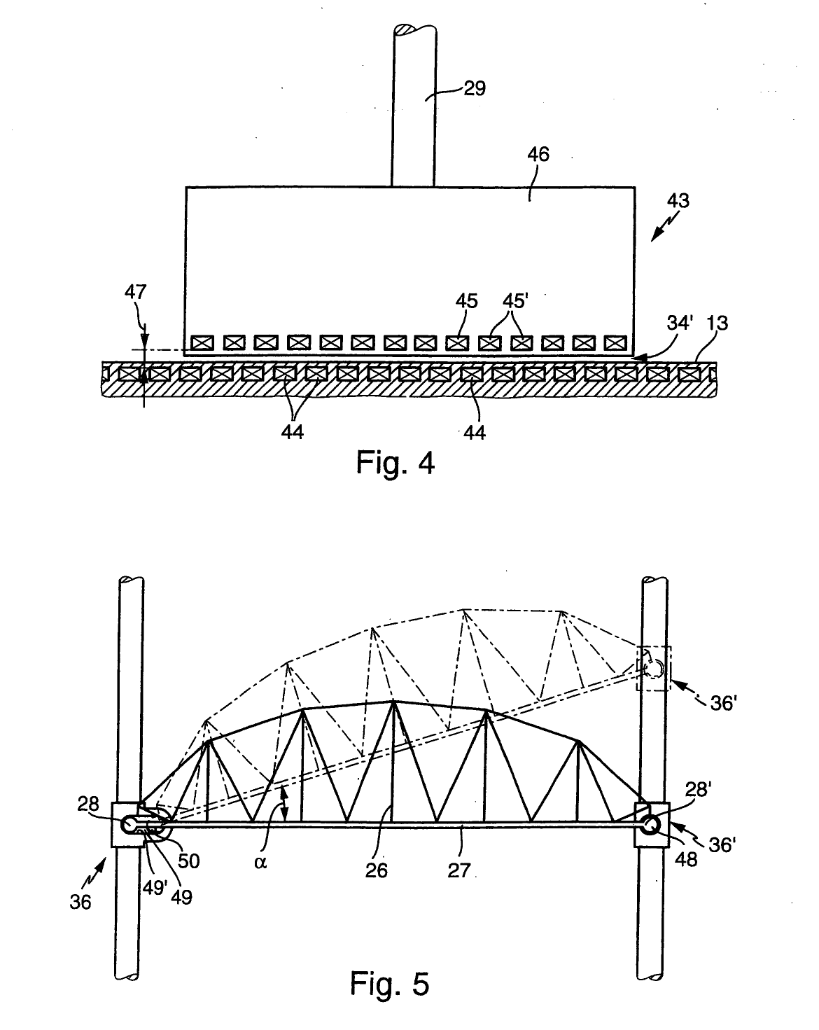

As an alternative to the band drives 37, in a second exemplary embodiment electromagnetic linear drives 43 are used to drive the gantry bridge 26. (See schematic representation of FIG. 4 as a detailed view of the foot 29 and the gantry bridge 26 in FIG. 2a). The functional principle of these drives 43 corresponds to a “developed for representation” electric motor. The electromagnetic linear drives 43 have the significant advantage in comparison with belt drives 37, of a contactless transmission of force and, in contrast to the belt drives 37, they do not require the use of mechanically moved force transmitting elements or transmission means. As a result, on the one hand, the quality of the simulation of the movement is improved since the friction in the system becomes minimal, particularly when the air bearings 34′ are used as supporting and guiding elements. On the other hand, the availability increases since there are no components available which are susceptible to wear (for example transmissions or steel belts), and which would require more frequent servicing intervals.

Both asynchronous and synchronous drives can be used as electric linear drives 43, as is the case in conventional rotational electric motors.

The functional principle of an asynchronous motor is based on active primary coils 44 that can be used to generate an alternating field, which in turn is used as a current in passive secondary coils 45. A force which brings about propelling forces as the field is moved on through the primary coils 44 acts in accordance with Lenz's law on the conductors of the secondary coil 45 through which current flows. Basically, both the primary and secondary coils 44, 45 can be installed in the “moved” part of the moutor—the rotor 46.

Asynchronous motors operate basically with slip (i.e., the resulting force is a function of the relative speed between the field and rotor 46). At low relative speeds, the rate of change of each field in the secondary coils 45, and thus the induced current, is lower, i.e. the generated forces are small. As the slip increases, the forces become larger. A second important influencing factor for the size of the generated forces is the level of the “magnetic air gap” 47 between the primary and second coils 44, 45; the strength of the induced current, and thus the resultant force, depends directly proportionally on the strength of the primary coil field. Its field strength in turn increases with the square of the level of the “magnetic air gap” 47. The “magnetic air gap” 47 must therefore be relatively small in the asynchronous drive (typically approximately 0.5 mm) in order to ensure a sufficient power density. Given a corresponding configuration for the gantry bridge 26, this leads to comparatively stringent requirements for tolerances and fabrication precision.

These disadvantages can be avoided when a synchronous motor is used: in contrast to an asynchronous drive in which the opposing field is generated in the secondary coils 45 by means of induction, in a synchronous motor the opposing field is “permanently installed” in the form of permanent magnets 45′. The alternating field which is generated by the primary coils 44 has to be moved on in synchronism with the rotor speed so that the magnetic attraction and expulsion forces between the poles of the primary coils 44 and the poles of the permanent magnets 45′ can be used for driving. The phase angle between the field of the permanent magnets 45′ and the field of the primary coils 44 is decisive for the magnitude of the driving force. In principle, the force of the motor is proportional to the current through the primary coils 44. The “magnetic air gap” 47 plays a significantly smaller role in a synchronous motor in comparison with an asynchronous motor. (That is, synchronous drives can be operated with comparable forces with a significantly larger “magnetic air gap” 47, typically 2 mm. In addition, the dependence of the force on air gap fluctuations is small due to the principle. This is above all also advantageous for controllability during operation, and thus for the meterability of the force.

In addition to the previously described driving of the gantry bridge 26 using two drives 36, 36′ arranged at end sides on the crossmember 27, it may be expedient to provide further force application points along the gantry bridge 26.

Regardless of whether belt drives 37 or electromagnetic linear drives 43 (FIG. 4) are used to move the gantry bridge 26, it is important to move the two ends 28 of the crossmember 27 in parallel and in synchronism with one another in order to avoid tilting of the gantry bridge 26. The drives 37, 43 are connected to the ends 28 of the crossmember 27, which transmit the (external) forces to the gantry bridge 26. For this reason, the electric motors 39 (FIG. 3), 43 (FIG. 4) of the drives 37 and 43 must be actuated synchronously. In order to permit small degrees of tilting without damage to the gantry bridge 26, one end 28′ of the crossmember 27 of the gantry bridge 26 is mounted to the drive 36′ via a hinge 48 and the other end 28 is free or is guided (in order to be able to transmit longitudinal forces) with respect to the drive 36 by means of a hinge 49 that is linearly displaceable in the Y direction to a limited degree. (In FIG. 5, which schematically illustrates tilting of the gantry bridge 26 in a greatly exaggerated form, this rotary connection 49 is embodied as an elongated hole 49′). If the drive fails or there is faulty synchronization of the two drives 36, 36′, tilting of the gantry bridge 26 in the X-Y direction can thus be compensated. However, when the crossmember 27 is mounted with such angular tolerance, there is a risk of uncontrolled angular deflection of the gantry bridge 26 over a large area in the form of a swinging movement. For this reason, in order to monitor the angular deflection, a switch 50 is provided within the displaceable hinge 49, and the switch 50 initiates the immediate disconnection of the drive motors 39 and 43 of the gantry bridge 26 when a maximum acceptable swinging angle α (for example of 1 degree) is exceeded.

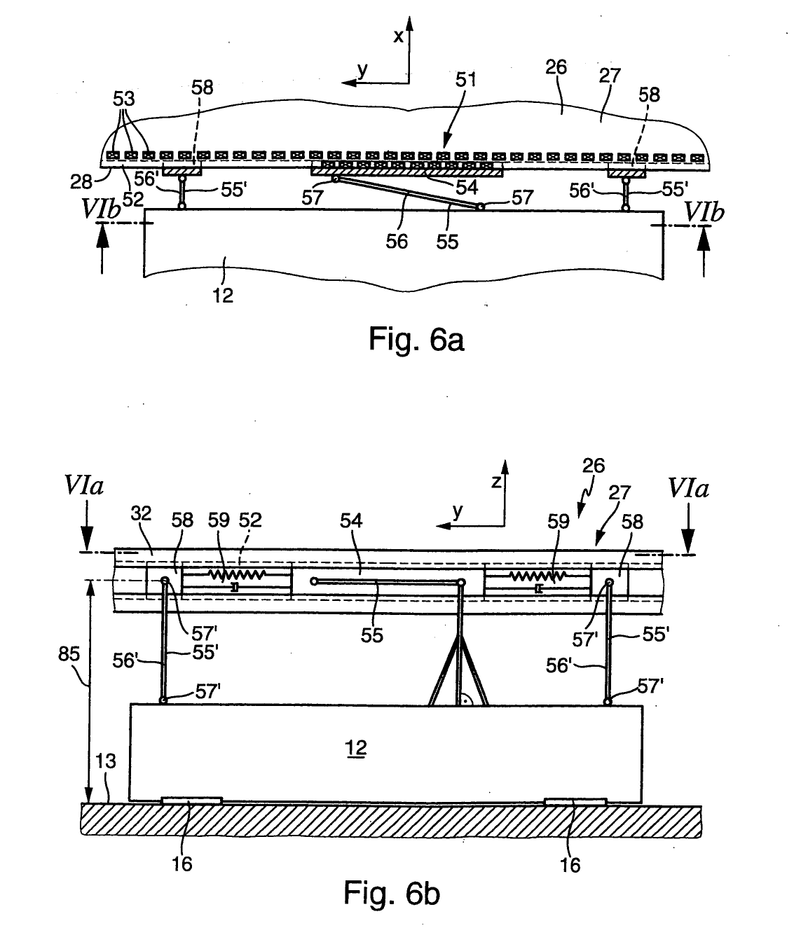

As is apparent for example from FIG. 2a, the first linear displacement unit 24 (FIGS. 1, 2a), which is used to displace and accelerate the base unit 14 in the Y direction, is attached in the area 28 of the gantry bridge 26 facing the base unit 14. In this area 28 the crossmember 27 has, as stated above, a shell structure 32 and therefore exhibits a particularly high level of rigidity. The first linear displacement unit 24 is preferably driven using an electric linear drive 51 (FIG. 2a). In order to guide the carrier carriage 12 with respect to the gantry bridge 26, a rail 52 which is orientated in the Y direction is provided in the region of the shell structure 32. The stator 53 of the electric linear drive 51 is expediently integrated into said rail 52, as is illustrated schematically in FIG. 6a in a plan view in the Z direction, and in FIG. 6b in a plan view in the X direction. The rotor 54 of the electric linear drive 51 is attached to the carrier carriage 12 by means of a central coupling element 55, which in turn comprises a rod 56 which is coupled to the rotor 54 and to the carrier carriage 12 by means of hinges 57.

In order to prevent rotary and/or rotational movements of the base unit 14 about the vertical (Z) axis, a further lateral coupling element 55′ is provided on each side of the central coupling element 55. One end of the rods 56′ of these lateral coupling elements 55′ is attached to the carrier carriage 12 by means of hinges 57′, and is attached at the other end by means of further hinges 57′ to supporting elements 58 which are displaceably guided in the rail 52 and are connected to the rotor 54 by means of spring damper elements 59. The forces which are applied to the gantry bridge 26 and the first linear displacement device 24 by the drives 34, 34′ and 51 are thus passed on to the carrier carriage 12 via the coupling elements 55, 55′ in order to produce movements of the base unit 14 in the horizontal plane (X-Y plane). The central coupling element 55 constitutes here a rigid connection between the rotor 54 and carrier carriage 12 in the Y direction, and thus serves to form a force connection to the base unit 14 in the Y direction. The two lateral coupling elements 55′ take up the forces in the X direction and the reaction torque of the base unit 14 about the Z axis when there is a Y movement of the base unit 14 or when the rotary plate 8 rotates.

The rail 52 is arranged, with respect to the base surface 13, at a level 85 which corresponds to the level of the center of gravity of the second linear displacement device 25, and to the level of the working point of the base unit 14 (i.e., the center of gravity of the base unit 14 in the normal position). The base unit 14 is thus coupled, at the level 85 of its working point, to the horizontal displacement device 11 so that moments owing to X and Y forces do not occur between the base unit 14 and the horizontal displacement unit 11. Although, as a result, the bearings 16 of the carrier carriage 12 have to support the base unit 14 statically and support the dynamic forces in the vertical direction, they do not have to support any (additional) moments from the X-Y forces. Furthermore, with this type of connection of the base unit 14 to the horizontal displacement unit 11, tilting of the base unit 14 due to driving forces and braking forces is ruled out.

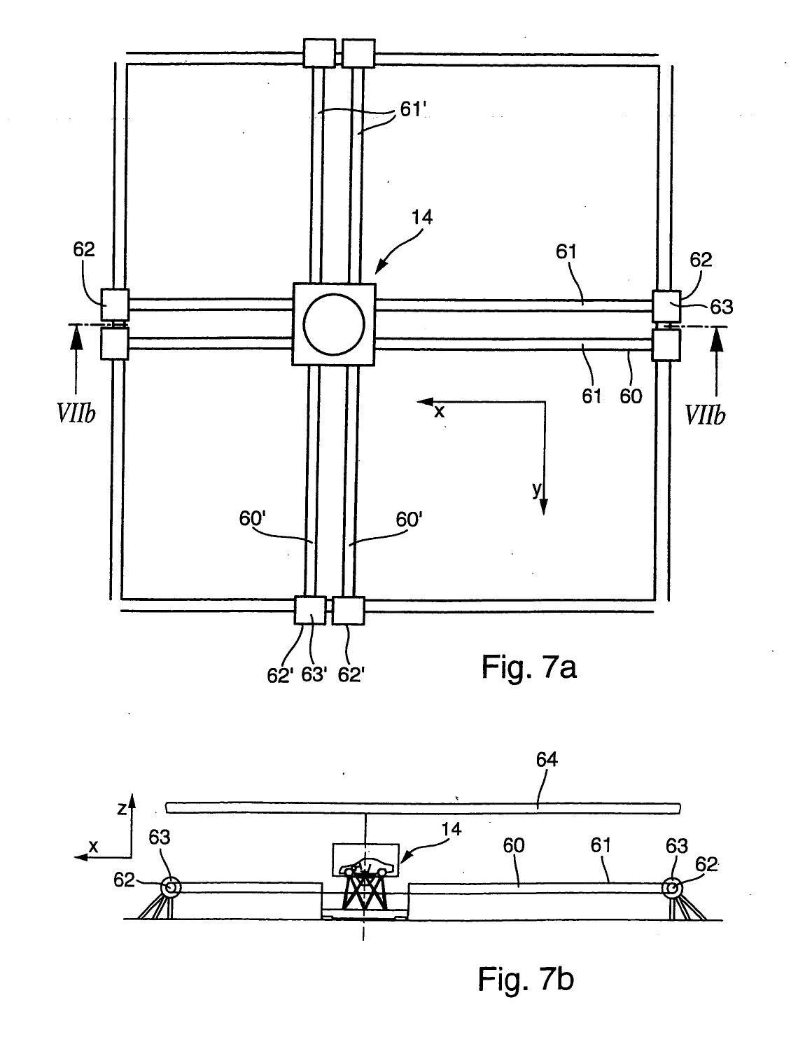

As an alternative to the cascaded embodiment of the horizontal displacement device 11 described above, in which a first linear displacement device 24 is mounted on a second linear displacement device 25 that is used to move the first linear displacement device 25, the horizontal displacement device 11 can also be implemented by means of a belt traction design in which the X and the Y movements are embodied by means of identical belt traction drives 60, 60′. This is illustrated schematically in FIGS. 7a and 7b.

For this purpose, two pairs of prestressed crossed-over steel belts 61, 61′ act on the carrier carriage 12, and run around a pair of drums 62, 62′ at each of the ends of the X-Y movement area 15. The drive is provided by means of electric motors 63, 63′ on the drums 62, 62′. In order to keep the steel belts 61, 61′ in each case in the correct position with respect to one another, the drums 62, 62′, and the electric motors 63, 63′ connected to them, must be moved along in synchronism and in parallel with the carrier carriage 12. The power supply to the base unit 14 is provided using a movable gantry crane 64 which is located above the carrier carriage 12 and is moved along in synchronism with the base unit 14.

The horizontal displacement device 11, which is shown in FIGS. 7a and 7b, and has a belt traction design, in comparison with the cascaded design in FIG. 1, has the advantage of minimizing the masses to be moved with a high quality. However, resonance phenomena of the belts 61, 61′ are a critical factor within the belt traction design. It is possible for this phenomena to be excited in particular as a result of chronologically varying action forces from the drive motors 63, 63′ or from the six-axle movement unit 10. The resonant frequency of the steel belts 61, 61′ depends here on the prestress, the material density and the free length; these parameters must be set in such a way that the natural frequencies of the steel belts 61, 61′ lie above the operating frequencies of the horizontal displacement device 11 (<1 Hz) and of the six-armed movement unit 10 (up to 3 Hz) in all cases. Relative to the gantry design of FIGS. 1a and 1b, the belt traction design in FIGS. 7a and 7b is a more complex system, since a plurality of different units (in each case four drive motors 63 and 63′, drives of the gantry train 64 for supplying power etc.) have to be driven in synchronism with one another.

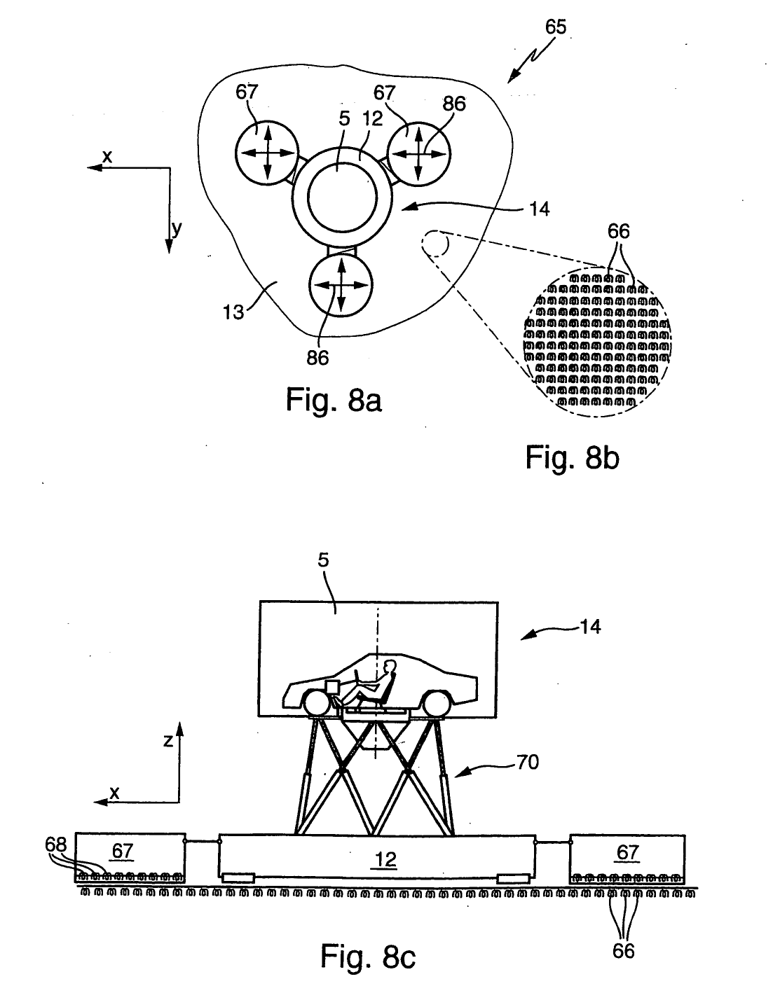

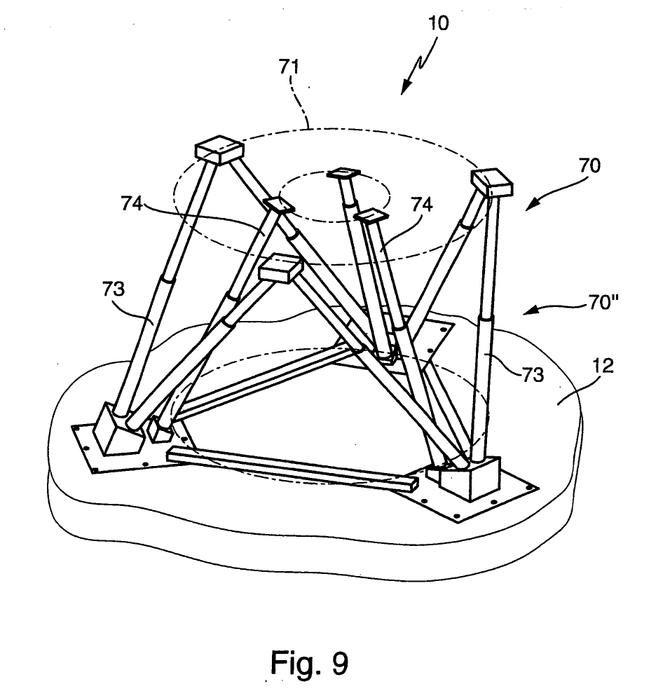

In a further exemplary embodiment (see FIGS. 8a to 8c), the horizontal displacement device is embodied as an electromagnetic planar drive 65. In this case, a two-dimensional grid of primary coils 66 is provided in the base surface 13 (as illustrated in the plan view of a detail of the base surface in FIG. 8b), with which primary coils 66 alternating fields can be generated in the X and Y directions. In order to excite movement of the base unit 14, a plurality of “shoes” 67 are provided which are fitted with secondary coils (or permanent magnets) 68 in their interior and are mounted with low friction (for example by means of air bearings) with respect to the base surface 13. When the fields are moved on by means of the primary coils 66, propulsion forces according to the arrows 86 in FIG. 8a are generated in the secondary coils (or permanent magnets) 68. In principle, the planar drive 65 can be embodied, analogously to the electromagnetic linear drives 43 of the gantry bridge 26, described above, as a synchronous drive or an asynchronous drive (with the associated advantages and disadvantages). The “shoes” 67 are moved in synchronism with one another and are connected to the carrier carriage 12 of the base unit 14 with air bearings by means of coupling elements 69. In order to be able to advantageously compensate the reaction forces exerted on the “shoes” 67 by the base unit 14, the “shoes” 67 should be arranged in a symmetrical (for example triangular or square) configuration with respect to the carrier carriage 12.

In the previously considered embodiment (FIG. 2a) the six-axle movement unit 10 comprises a hexapod 70 and is used to simulate the reciprocating, rolling and pitching movement in the frequency range up to at least 3 Hz and to simulate the X and Y movements in the frequency band of approximately 1 Hz up to at least 3 Hz. The yaw movement is transmitted by the rotary plate 8 which is arranged on the movement platform 71 of the hexapod 70. The reaction moments from the yaw movement have to be taken up by the hexapod 70 and transmitted to the carrier carriage 12.

Either a hydraulically or electrically operated hexapod 70′, 70″ can be used as the hexapod 70. A hydraulically operated hexapod 70′ has the advantage of high energy density in comparison with an electrically operated hexapod 70″. In order to be able to represent large lengths and angles, differential cylinders with a special valve (adapted to the surface conditions of the cylinder) are preferably used as hydraulic cylinders 72. The weight of the hexapod 70′ itself is just 2.5 t, and in addition it is necessary to take into account supply hoses from and to the assembly (not illustrated in FIG. 2a) with an empty weight of approximately 2 t on the horizontal displacement device 11. Alternatively, the assembly can be moved along on the carrier carriage 12, and in this case the hoses on the horizontal displacement device 11 are dispensed with, but the weight on the carrier carriage 12 is increased by approximately 3 t.

Alternatively, it is possible to use an electrically operated hexapod 70″ which has higher dynamics than the hydraulically operated hexapod 70′. When an electrically operated hexapod 70″ is used, the moved mass can be halved in comparison with the hydraulic hexapod 70′, and in addition the power requirement of the hexapod 70 can also be halved in comparison with the hydraulic variant.

An example of an electric hexapod 70″ which is suitable for this application is illustrated in FIG. 9; it comprises six electromagnetic actuators 73 which are attached at the top to the movement platform 71 and at the bottom to the carrier carriage 12. The actuators 73 are provided with mechanical brakes (not illustrated in FIG. 9) which are opened actively by means of a magnetic clutch; they are also equipped with electric brakes, acting as dampers (not illustrated in FIG. 9 either) in the form of drive electric motors which are short-circuited by means of resistors. As a result it is possible to bring the hexapod 70″ automatically to a standstill when necessary, and in the process to freeze it in its current position in order to avoid movement of the hexapod 70″ due to the movement of the horizontal displacement device 11.

In addition, three pneumatic cylinders 74 are provided to support the static basic load. This geometric configuration ensures that the hexapod 70″ is lowered automatically into a level, stable position in almost all cases when the horizontal displacement device 11 is stationary, the actuators 73 are short-circuited, the pneumatic system 74 is switched off and the brakes are released. As an alternative to the tetrahedron-like arrangement of the pneumatic cylinder 74 in FIG. 9 it is also possible to use six pneumatic cylinders which are arranged in parallel with the actuators 73.

The overall weight of the electrically operated hexapod 12, together with the associated electronics and pneumatics, is almost 3 t; the payload is approximately 3.5 t. The electrical actuators 74 are controlled using a PC-based real time computer, and six digital amplifiers. Furthermore, a pressure accumulator with approximately 300 l volume and a pressure of 3 bar is required.

As is apparent from FIG. 2a, a rotary plate 8 on which the cabin 5 with the ride actuating system 6 is mounted is integrated into the movement platform 71 of the hexapod 70. In order to be able to implement novel motion simulations (for example the so-called “centrifuge mode”) with the driving simulator 1, the rotary plate 8 is configured in such a way that it permits the vehicle cabin 5 to rotate freely through angles of any desired size. The components of the ride actuating system 6 are let into the rotary plate 8 in its center, and the closed-loop and open-loop control electronics of the ride system 6 are also accommodated in the rotary plate 8.

A hydraulic motor with support by means of suitable transmission, an electric motor with step-down transmission or a direct electric drive can be used as the drive of the rotary plate 8. It is appropriate to use a hydraulic motor in particular if a hydraulically operated hexapod 70′ is used, otherwise it is disadvantageous to use a hydraulic motor because it requires an independent pressure supply just for the rotary movement.

Using a direct electric drive to excite movements of the rotary plate 8 has the advantage that in this way it is possible to dispense completely with mechanical coupling elements such as transmissions or toothed belts which are not only subject to friction but are also susceptible to wear. The motor is preferably integrated between the movement platform 71 and rotary plate 8 so that the rotary plate 8 forms the rotor, and the surrounding area of the movement platform 71 forms the stator of the electric motor.

The driver's cabin 5 with the ride actuating system 6 which is near to the driver and is used to represent vehicle oscillations above 3 Hz is mounted on the rotary plate 8. Such high-frequency oscillations are mainly perceived by a test person 3 as vibrations at haptic interfaces (seat 75, steering wheel 76, pedal 77). A majority of the requirements made of the ride actuating system 6 relate to oscillation variables which act on the driver's seat unit 75. For this reason, a movement concept for the driver's seat 75 is considered in what follows, which concept is then also applied, after corresponding scaling and modification, to the other ride-related vehicle parts such as, for example, steering wheel 76 or baseplate with pedal system 77.

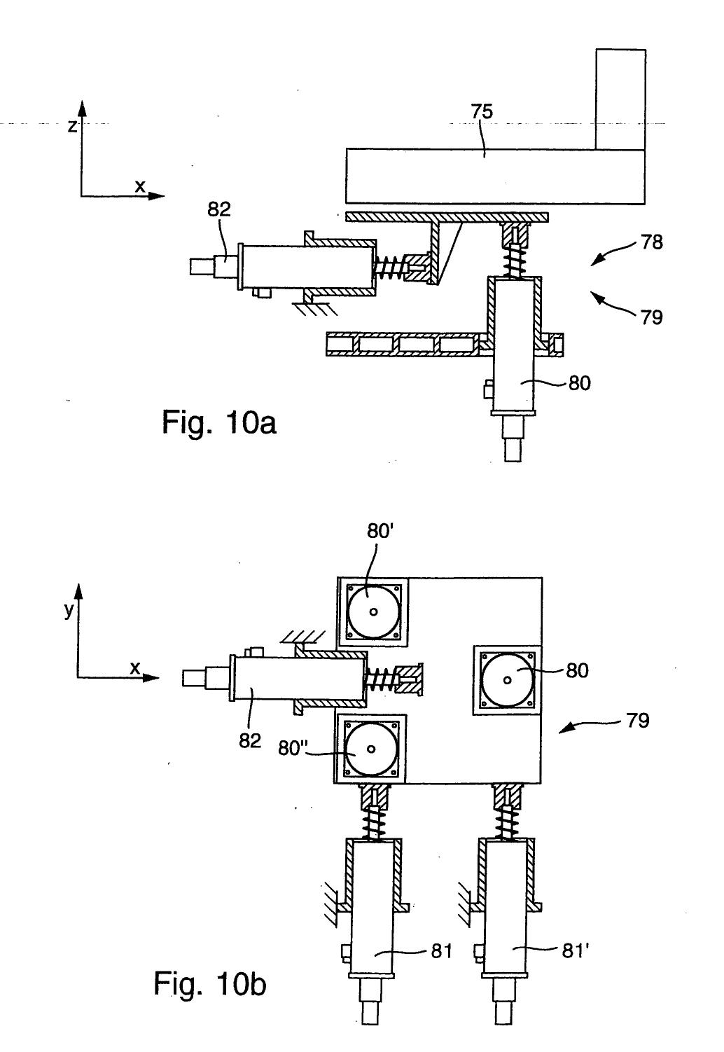

In order to configure an actuating system 78—placed under the driver's seat 75—in order to represent the vehicle oscillations between 3 Hz and 30 Hz under conditions which are close to reality, it is first necessary to select a suitable kinematic system. To represent this frequency range a small movement area of 8 mm×4 mm×20 mm is sufficient, for which area the kinematics of a resolved hexapod 79 can advantageously be used. FIGS. 10a and 10b show an advantageous embodiment of such a kinematic system in a schematic X-Z sectional view and a schematic X-Y view, respectively. The actuating system 78 for the driver's seat comprises three actuators 80, 80′, 80″ in the Z direction, two actuators 81, 81′ in the Y direction and an actuator 82 in the X direction. The significant advantage of using a resolved hexapod kinematic system is the linear consideration of the overall movement system 79 on the basis of the orthogonal arrangement of the actuators 80-82 and of the small movement area. Such a system can be controlled in terms of regulating technology using the state regulating system at the level of an individual actuator and can also be operated in the high-frequency range in all the spatial directions with an excellent performance. Electric actuators 80-82 are advantageously used for the ride actuating system 6. Each individual actuator 80-82 is composed here of an electric drive, the spring which is connected in parallel therewith and a suitable bearing system for connecting the structure. The springs are necessary to relieve the actuators 80-82 of static loads. The damping of the system is implemented by means of regulating equipment.

The emergency operating properties of the ride actuating system 6 must be configured on an overall model of the cascaded movement system 2. When the power supply fails, the electric drives 80-82 are short-circuited by resistors so that the ride actuating system 6 becomes a heavily damped spring mass system. Because of the very small movement area, power-absorbing stops are additionally provided. Mechanical brakes can alternatively or additionally be provided for securing the ride actuating system 6.

The safety concept of the overall movement system 1 is configured such that the test person 3 cannot be injured in the simulator 2 under any circumstances. An essential criterion here is that the acting accelerations do not exceed a specific threshold, for example when the system is braked to a standstill because an actuator has failed. For the normal simulator mode, accelerations up to a maximum of 10 m/s2 are assumed. Furthermore, it is necessary to ensure that the simulator itself and the surroundings are not damaged under any circumstances. The central point here is to gently brake the moved mass without damaging any components such as, for example, the air bearings 16 or the base surface 13.

The central focus of the safety concept is to detect safety-critical situations and then place the system in a safe state. This can be carried out in multiple stages so that when a component system fails, other component systems, which remain operable, can be used to move gently into a safe state. A prerequisite here is that all the air bearings 16, 34 have their full carrying effect during the short time period until the safe or stationary state of the movement system 1 is reached, which is ensured by correspondingly configured pressure accumulators. The air bearings 16, 34 themselves must be monitored continuously in order to be able to stop the system 1 automatically when there is a possibly occurring drop in pressure.

In what follows, the safety concept is considered using the example of a complete failure of the movement system 1 due to interruption of the power supply of all the actuators 6, 8, 10, 11, during which the system 1 must be placed automatically in the safe state.

The least critical factor here is the actuator 83 for the steering wheel 76 which is simply de-energized when the power supply is interrupted and no longer provides any torque, so that the steering wheel 76 can thus be freely rotated. In all the other moved component systems (ride actuating system 6, rotary plate 8, hexapod 70 and horizontal displacement device 11) the individual actuators are configured in such a way that when the power supply is interrupted they are braked automatically and the system thus comes as quickly as possible to a standstill while taking into account the maximum acceptable decelerations. Owing to the small movement area of the ride actuating system 6, the seat 75 and pedal 76 thus remain virtually in their normal position. In the case of the rotary plate 8, the standstill position is insignificant.

In the most unfavorable case, the hexapod 70 comes to a standstill in a position in which the movement platform 71 is at an extreme incline. For this reason, a second emergency operating stage, with which the movement platform 71 is lowered gently into a horizontal position after the overall system 1 has come to a standstill, is also provided here. This is achieved, for example, by releasing the brakes and using the actuators 72, 73 as dampers. For this purpose (in the case of an electrically operated hexapod 70′), they are electrically short-circuited with correspondingly configured resistors or (in the case of a hydraulically operated hexapod 70″) their pressure is released via corresponding outflow valves.

With respect to the safety concept of the horizontal displacement device 11, the cascaded embodiment of FIGS. 1 to 6—composed of the gantry bridge 26 and the first linear displacement device 24 attached to it—will be considered in what follows as a special case. The main objective here is to prevent excessive angular deflections of the crossmember 27, which are critical for safety. Either mechanical brakes which have a constant braking force (i.e. one which is independent of the speed of the drives) are used as brakes for the electric drives 36, 36′, 51 of the gantry bridge 26 and of the first linear displacement device 24, or the electromagnetic drives 36, 36′, 51 themselves are used as brakes by short-circuiting with correspondingly configured resistors, in which case a braking force proportional to the speed is obtained. It is also possible to combine the two principles. Since the braking force always acts in the drive direction and since the horizontal displacement unit 11 comprises a plurality of drives 36, 36′, 51, the deceleration which results when all the drives 36, 36′, 51 have the same constant braking force is always direction-dependent. If, for example, the horizontal displacement device 11 brakes both in the X direction and in the Y direction with a 10 m/s2 corresponding deceleration, a deceleration of 14 m/s2 is obtained when traveling in the diagonal direction.

If mechanical brakes which apply a constant braking force in the X and Y direction are provided on the drives 36, 36′, 51, in each case an approximately constant deceleration of 7.1 m/s2 is obtained in each axial direction X, Y, and a braking distance of 7.1 m is thus obtained. In the Y direction, this is essentially independent of the position of the carrier carriage 14. In contrast, in the X direction, the carriage position has a large influence: if the carrier carriage 12 is located outside the center, the center of gravity of the base unit 14 is displaced with respect to the center, which results in different braking distances along the two guides 35, 35′ and thus an angular deflection of the crossmember 27, given constant, equally large braking forces to the left and right. This can be partially compensated by adding (electromagnetic) dampers in the X direction which apply a braking force in proportion to the speed. An undesirably large angular deflection of the crossmember 27 can thus be prevented. Furthermore, buffers 84 are provided which bring the horizontal displacement device 11 completely to a standstill in the worst case of only insufficiently acting brakes.

In terms of the general configuration of the brakes of the movement system 1 it is necessary to consider the fact that the driver's seat 75 and hexapod 70 are each braked with respect to the horizontal displacement device 11, which is itself braked at that particular time. The braking must therefore take place hierarchically in such a way that the system with the smallest (relative) movement area (that is to say the driver's seat 75) comes to a standstill first, and then the hexapod 70 and then the horizontal displacement device 11. However, in order to bring about the fastest possible braking, all the systems 75, 70, 11, must brake as far as possible simultaneously, and no system can wait for another to stop completely. This means that when braking takes place, the driver's seat 75 experiences an intermediate reduction in speed, the hexapod 70 experiences a middle-ranking reduction in speed and the horizontal displacement device 11 experiences the smallest reduction in speed. In the converse case, for example when the gantry bridge 26 is braked, the hexapod 70 would otherwise simply “travel on” into its stops owing to excessively small braking forces.

If air bearings 16, 34 were considered for the low-friction bearing of the carrier carriage 12 and of the support 33 of the gantry bridge 26 in the previously considered embodiment, these components can in principle also be provided with bearing in the form of low-friction roller bearings or sliding bearings.

Instead of a hexapod 70 it is possible for the six-axle movement unit 10 also to be implemented by means of a resolved hexapod kinematic system, analogous to the kinematic system described above for the driver's seat unit 75.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-19. (Cancelled).

20. A system for generating movement in a driving simulator for producing motion sensations on test persons, said system comprising:
a cabin which houses a seat and operator controller elements, the seat or controller elements being movably arranged by means of holders and being displaceable in a variable fashion with respect to one another, in a plurality of directions of movement under control of a control unit; and
a manipulator to which the cabin is fixedly mounted; wherein,
the manipulator comprises a rotary plate for controlled rotational movement of the cabin about its vertical axle, a six-axle movement unit for moving the rotary plate and cabin collectively in six degrees of freedom and a horizontal displacement device for controlled displacement and acceleration of an assembly composed of the six-axle movement unit, rotary plate and cabin along the two horizontal axes; and
the six-axle movement unit is fixedly mounted on a carrier carriage which is mounted in a freely displaceable fashion on a planar base surface bounded by movement paths of the horizontal displacement device, and is pulled or pushed with respect to this base surface by means of the horizontal displacement device.

21. The movement system as claimed in claim 20, wherein the carrier carriage is mounted on the base surface by one of air bearings and air cushions.

22. The movement system as claimed in claim 20, wherein the horizontal displacement device comprises two linear displacement devices, including:
a first linear displacement device for controlled displacement and acceleration of the assembly composed of the six-axle movement unit, rotary plate and cabin along a first horizontal axis; and
a second linear displacement device for controlled displacement and acceleration of the assembly composed of the first linear displacement device, six-axle movement unit, rotary plate and cabin along a second horizontal axis which is oriented approximately perpendicularly with respect to the first horizontal axis.

23. The movement system as claimed in claim 22, wherein the second linear displacement device comprises a gantry bridge.

24. The movement system as claimed in claim 23, wherein the gantry bridge is supported on the base surface by one of air bearings and air cushions.

25. The movement system as claimed in claim 22, wherein movement excitation of the gantry bridge is carried out by two belt traction drives which are arranged at ends of the gantry bridge.

26. The movement system as claimed in claim 22, wherein movement excitation of the gantry bridge is carried out by means of two electromagnetic linear drives which are arranged at ends of the gantry bridge.

27. The movement system as claimed in claim 25, wherein the gantry bridge is connected to one of the two drives by a hinge and is mounted to the other drive via a rotary connection which can be displaced linearly in the Y direction to a limited degree.

28. The movement system as claimed in claim 23, wherein the first linear displacement device is driven by an electromagnetic linear drive which can displace the assembly composed of the six-axle movement unit, rotary plate and cabin with respect to the gantry bridge.

29. The movement system as claimed in claim 22, wherein the carrier carriage is supported with respect to the first linear displacement device by means of coupling elements.

30. The movement system as claimed in claim 22, wherein the first linear displacement device is connected to the second linear displacement device at a level which corresponds to a level of a center of gravity of the second linear displacement device.

31. The movement system as claimed in claim 22, wherein the at least one drive of the first linear displacement device or the at least one drive of the second linear displacement device are provided with a passive brake system.

32. The movement system as claimed in claim 22, wherein at least one of the first and second linear displacement devices is provided with an end stop for transferring forces occurring in the case of braking.

33. The brake system as claimed in claim 20, wherein the horizontal displacement device is formed by one of two belt traction drives and two pairs of belt traction drives, whose directions of action are approximately perpendicular to one another.

34. The movement system as claimed in claim 20, wherein the horizontal displacement device is formed by an electromagnetic planar drive.

35. The movement system as claimed in claim 34, wherein the electromagnetic planar drive comprises at least two electromagnetically driven displacement shoes which can be moved synchronously with one another and to which the carrier carriage is mechanically coupled.

36. The movement system as claimed in claim 20, wherein the six-axle movement unit is moved by electric drives.

37. The movement system as claimed in claim 20, wherein the six-axle movement unit is a hexapod.

38. The movement system as claimed in claim 20, wherein the cabin is arranged in a dome which is permanently connected to the rotary plate.

39. A motion simulator for stimulating sensations of movement for an occupant, said motion simulator comprising:
a planar base surface;
a carrier which is supported and freely displaceable on the planar base surface;
a horizontal displacement device for controlled displacement and acceleration of the carrier on the planar base surface;
a rotary plate;
a six-axle movement unit fixedly mounted on the carrier and supporting the rotary plate, for moving the rotary plate in six degrees of freedom, and for generating a controlled rotational movement of the rotary plate about an axis normal to the rotary plate;
a cabin mounted to said rotary plate; and
a seat and operator controls that are movably arranged in the cabin by means of holders, and are displaceable relative to each other by assigned actuating elements in a plurality of directions, under control of a control unit.
